(19) United States
(12) Patent Application Publication
(10) Pub. No.: US 2016/0174528 A1
(43) Pub. Date: Jun. 23, 2016

(54) ROTATABLE HORSE LIFTING AND SUPPORTING DEVICE

(71) Applicant: Donald Jennings Dyson, Escondido, CA (US)

(72) Inventor: Donald Jennings Dyson, Escondido, CA (US)

(21) Appl. No.: 14/834,351

(22) Filed: Aug. 24, 2015

Related U.S. Application Data
(60) Provisional application No. 62/070,599, filed on Aug. 29, 2014.

(51) Int. Cl. A01K 15/04; A61D 3/00

(52) U.S. Cl. CPC A01K 15/04; A61D 3/00

(57) ABSTRACT

A four-legged animal lifter. Lifting straps extend downward from a rotatable horse support structure. Four harnesses are connected to the lifting straps and are attached to the legs of the four-legged animal. A lifting apparatus is attached to the rotatable horse structure and is for lifting the four-legged animal upwards to reduce weight on the animal's legs. In preferred embodiment the four-legged animal is a horse.

The present invention relates to horse lifting devices, and in particular to lifting devices for injured horses. This application claims the benefit of Provisional Application 62/070,599 filed Aug. 29, 2014, which is incorporated by reference herein.

### BACKGROUND OF THE INVENTION

There is no effective system of lift and support which reduces the weight felt on a horse's lower leg segments, including hooves, during an extended rehabilitation process. Indeed, horses who have broken a leg are euthanized approximately 95 percent of the time. Often the horse is euthanized because of severe laminitis. Large contributing factors for euthanizing the horse also include too much weight on the injured legs and hooves and not allowing proper time for healing.

Prior art methods of attempted relieving of weight from lower legs and hooves have not been proven effective. Currently the horse must stand erect, and weight taken from one healing limb is almost always shifted to one or more of the other legs. The lifting points on the horse are not effective and do not provide the horse the mobility to walk on their own during the extended rehabilitation process.

What is needed is an effective horse lifting device to reduce pressure on the horse's broken leg as well as the other three of the horse's legs during long term rehabilitation during long term rehabilitation.

### SUMMARY OF THE INVENTION

The present invention provides a four-legged animal lifter. Lifting straps extend downward from a rotatable horse support structure. Four harnesses are connected to the lifting straps and are attached to upper legs of the four-legged animal. A lifting apparatus is attached to the rotatable horse structure and is for lifting the four-legged animal upwards to reduce weight on the animal's legs. In a preferred embodiment the lifting apparatus includes a hydraulic lifter for lifting the rotatable horse support structure and four independently controllable winches for independently lifting each of the four-legged animal's legs. In preferred embodiment the four-legged animal is a horse.

### BRIEF DESCRIPTION OF THE DRAWINGS

FIG. 1 shows a front view of a horse with harnesses attached.

FIG. 2 shows a side view of a horse with harnesses attached.

FIG. 3 shows a bottom view of a horse with harnesses attached.

FIG. 4 shows a preferred rotatable horse lifter.

FIG. 5 shows a top view of a preferred rotatable horse lifter.

FIG. 6 shows a side view of a preferred containment stall.

FIG. 7 shows a front view of a preferred containment stall.

FIG. 8 shows a front view of a preferred containment stall.

FIG. 9 shows a preferred containment stall with removed doors.

FIG. 10 shows a preferred control connectivity arrangement.

FIGS. 11-12 show preferred framing for the containment stall.

FIG. 13 shows a preferred leg harness.

FIG. 14 shows a detailed view of lift loops sewn into the connection straps of a preferred leg harness.

### DETAILED DESCRIPTION OF THE PREFERRED EMBODIMENTS

The present invention utilizes four harnesses, one for each of the four legs of a horse. One harness attaches to each of the two forelegs and one harness attaches to each of the two rear legs. These harnesses are positioned at the upper part of each leg, providing the most optimum lifting and supporting areas for long-term rehabilitation, which can be days and weeks. These are the strongest areas of the legs and yet allow the horse to move its legs forward and back while walking about, exercising legs and all body parts during long-term rehabilitation periods. Moreover, an equine veterinarian may examine each leg regularly for rubbing and chafing. This person may also examine the lifting and supporting weights on each leg to insure proper balance for complete body healing.

Please note that the harnesses may be of a variety of materials such that they are strong, durable, washable, pliable, and suitable to the various horses' bodies. Also, each may have linings, to be in direct contact with the horse's skin, of soft materials allowing the easy flow of blood along and through veins and arteries which may run close to the surface of the horse's legs. Sheepskin, or synthetic fleeces, or any appropriate, approved lining materials may be used for a particular horse, given the time frame necessary for rehabilitation from particular diseases or injuries. What is needed is a “good fit” against a horse's skin for comfort, and to eliminate sores, shock, and rubbing.

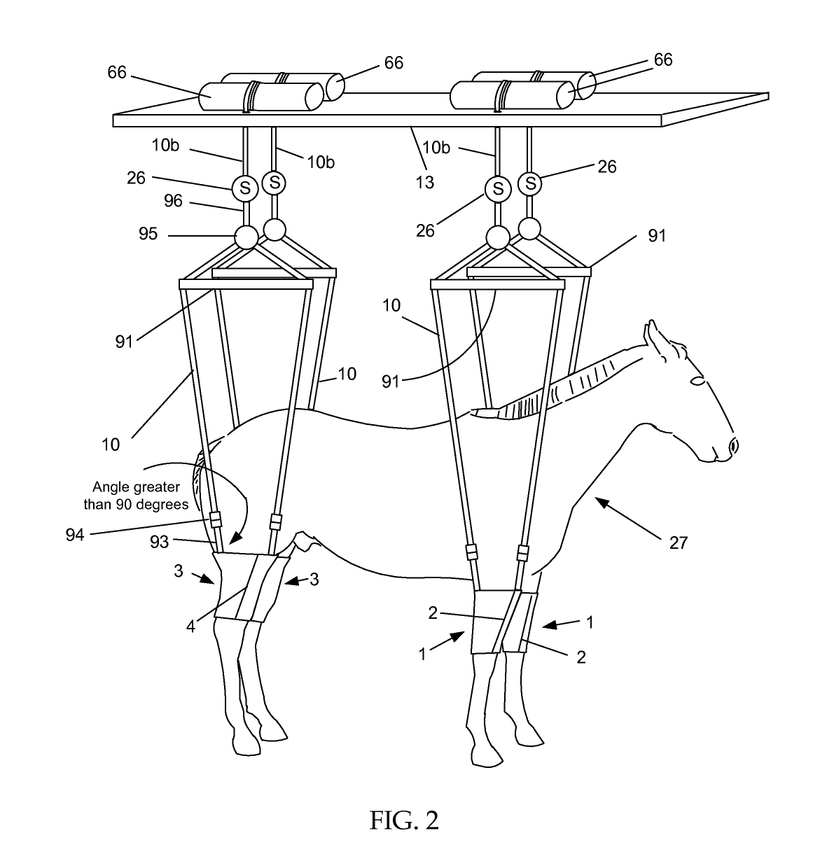

For example FIG. 2 shows foreleg harnesses 1 and rear leg harnesses 3 attached to horse 27. In a preferred embodiment, the four harnesses are appropriately positioned for optimum lifting and rehabilitation. Each foreleg harness 1 is preferably positioned between the top of the knee joint, also known as carpuses, to the bottom of the elbow joint. Given the specific injury to the horse, and the multitude of other considerations in the healing process, the majority of the lifting in these two foreleg is preferably between the areas from the elbow joint to approximately 6-8 inches below the elbow joint. Or as recommended by equine veterinarians and other trained horse professionals.

Each rear leg harness 3 is preferably positioned from the top of the taruses, also known as hock joint, to the stifle joint. Likewise, given the specific injury to the horse, and the multitude of other considerations in the healing process, the majority of the lifting in the two rear legs is preferably between the areas from the stifle joint to approximately 6-8 inches below the stifle joint. Or as recommended by equine veterinarians and other trained horse professionals.

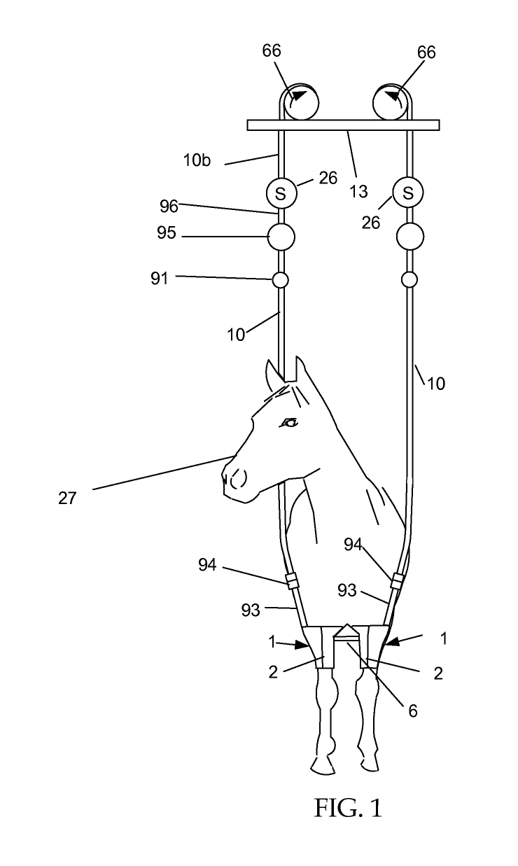

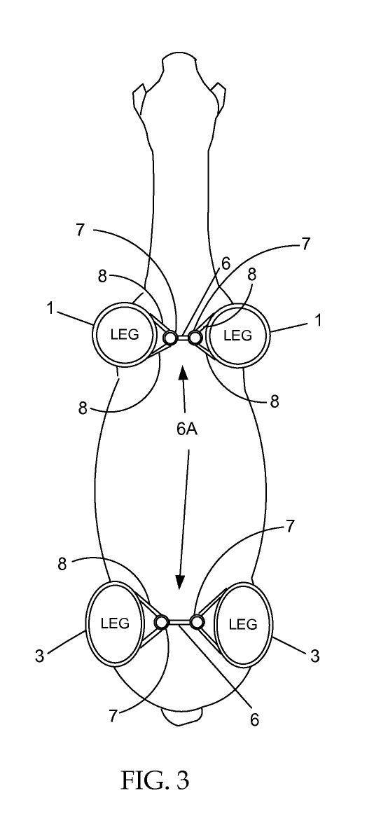

FIGS. 1 and 2 show a preferred embodiment of the present invention. Foreleg harnesses 1 are connected to the forelegs of the horse via VELCRO® hook and loop fastener 2. Rear leg harnesses 3 are connected to the rear legs via hook and loop fastener 4. Strap 6 (FIG. 1) is connected between right foreleg harness 1 and left foreleg harness 1 and between rear leg harness right harness 3 and rear leg left harness 3 to prevent spreading of the legs (see also FIG. 3). Underbody strap connection mechanism 6A also includes buckles 7 and connection straps 8.

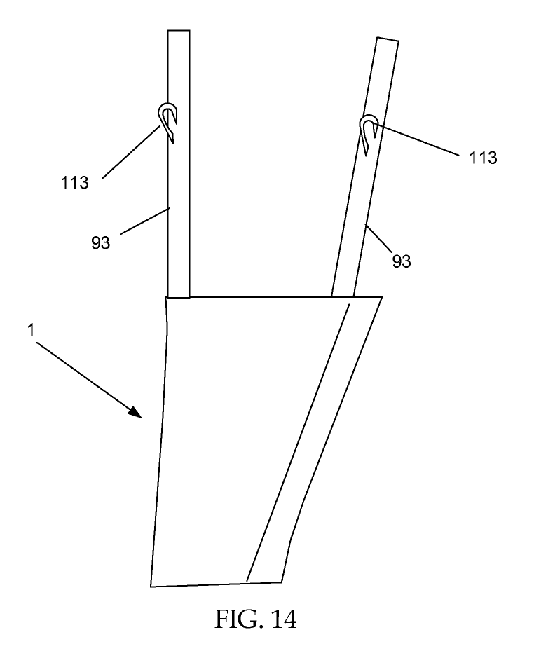

Lifting straps 10 (FIGS. 1 and 2) are connected to harness connection straps 93 by utilizing metal connectors 94. FIG. 14 shows a detailed view of lift loops 113 sewn into connection straps 93 of harness 1. Metal connectors connected to straps 10 connect to lift loops 113. Lifting straps 10 are guided through spreader bar 91 as shown. Spreader bars 91 increase the angle of lifting straps 10 as they extend upwards from harnesses 3 and 1. The angles of the lifting straps 10 are no longer approximately perpendicular. Instead they are greater than 90 degrees. This allows for optimum lift of the horse's legs, more effective support of the horse and better rehabilitation.

Scales 26 are connected to the stranded wire ropes of the winches, which wind around the winches, as shown. The readings are preferable in pounds and may be read on centrally located instruments. The remote controlled, electrical winches 66 are connected to the top of overhead 13. Stranded wire ropes wind around winches 66.

Lifting straps 10 are connected to strap guide 95. Strap 96 extends upward from strap guide 95 and is connected to scale 26 Remote controlled electrical winches 66 are connected to the top of overhead 13. Wire winch lines 10b are wound around winches 66, as shown. The tension on straps 10 can increase or decrease by engaging winches 66. The amount of force (weight) is recorded through scales 26.

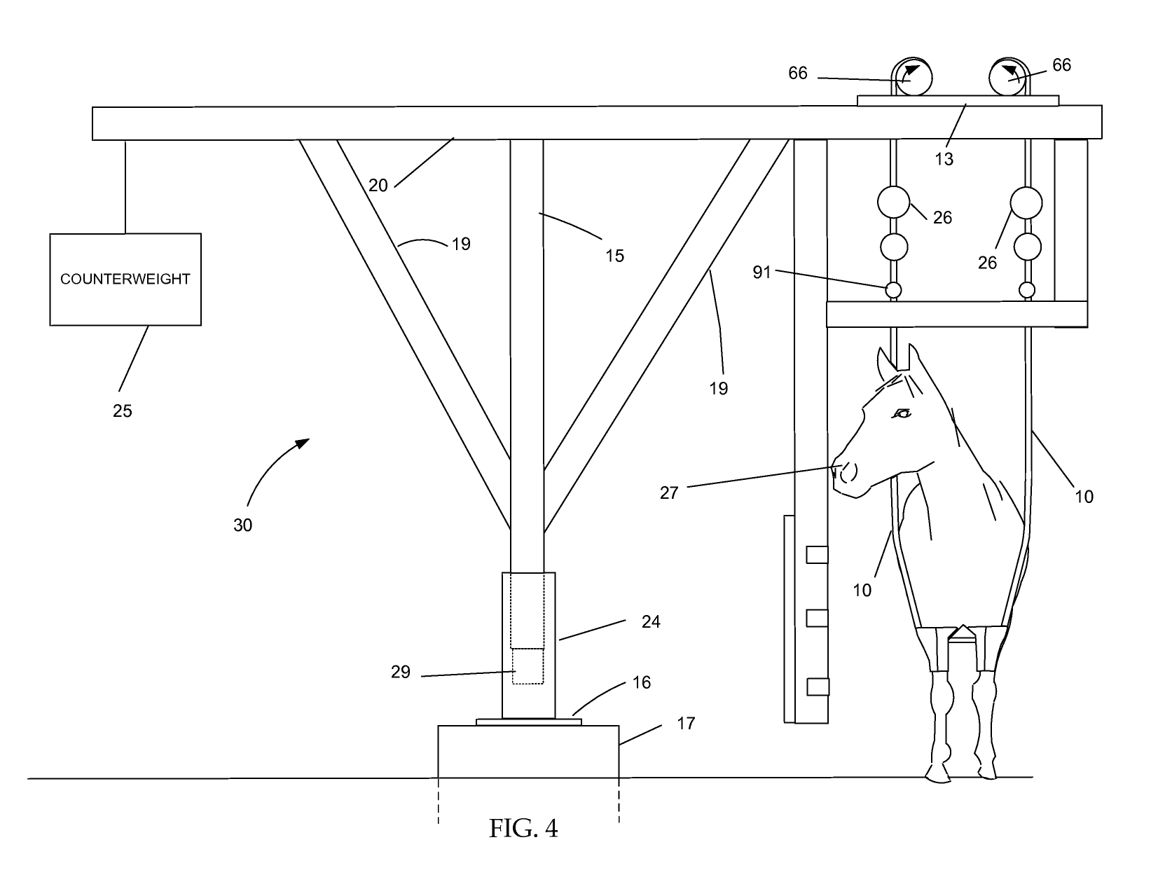

FIG. 4 shows a front view of horse 27 connected to preferred rotatable horse lifter 30. Support pole 15 is positioned above hydraulic lifter 29 (inside lifter casing 24). In a preferred embodiment hydraulic lifter 29 is a hydraulic cylinder lifter capable of lifting 6000 pounds a vertical distance of 10 inches and is manufactured by Miller Fluid Power with offices in Bensenville, Ill. (part no. HV350R2B-00400-01000-0175-97). Hydraulic lifter 29 is rigidly mounted on rotatable disc 16. Rotatable disc 16 allows for 360 degree rotation of horse lifter 30. Rotatable disc 16 is mounted onto concrete mounting base 17. Support beams 19 provide stability and support for horizontal support beam 20. Counterweight 25 is connected to the left side of beam 20 and balances the weight of horse 26.

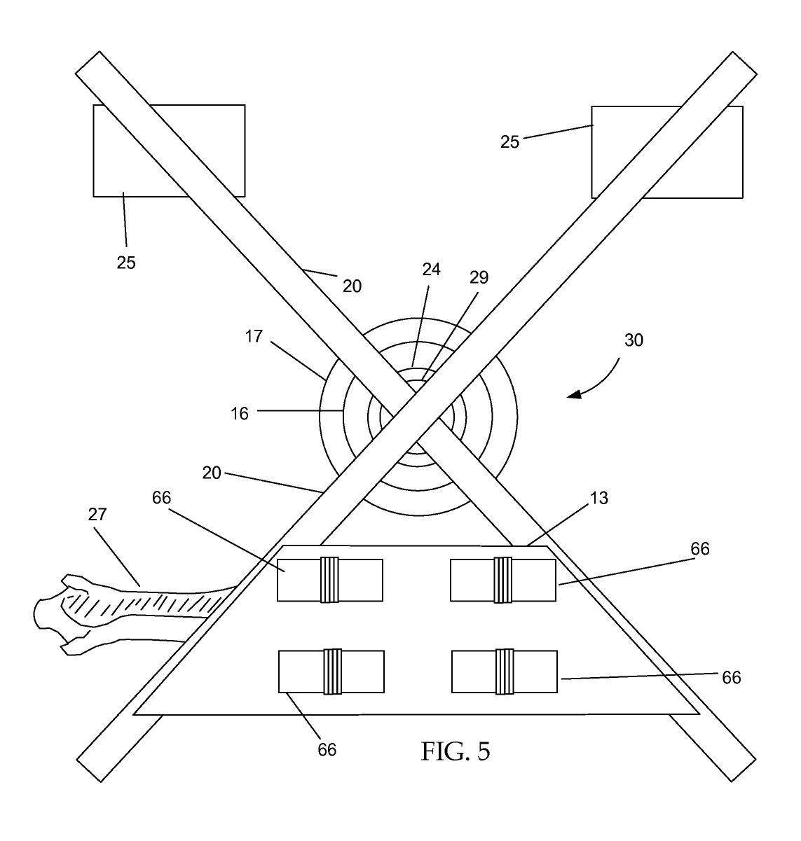

FIG. 5 shows a top view of horse lifter 30. Horse 27 is supported by overhead support 13 connected to beams 20. Horse lifter 30 is raised and lowered via hydraulic lifter 29 as explained above.

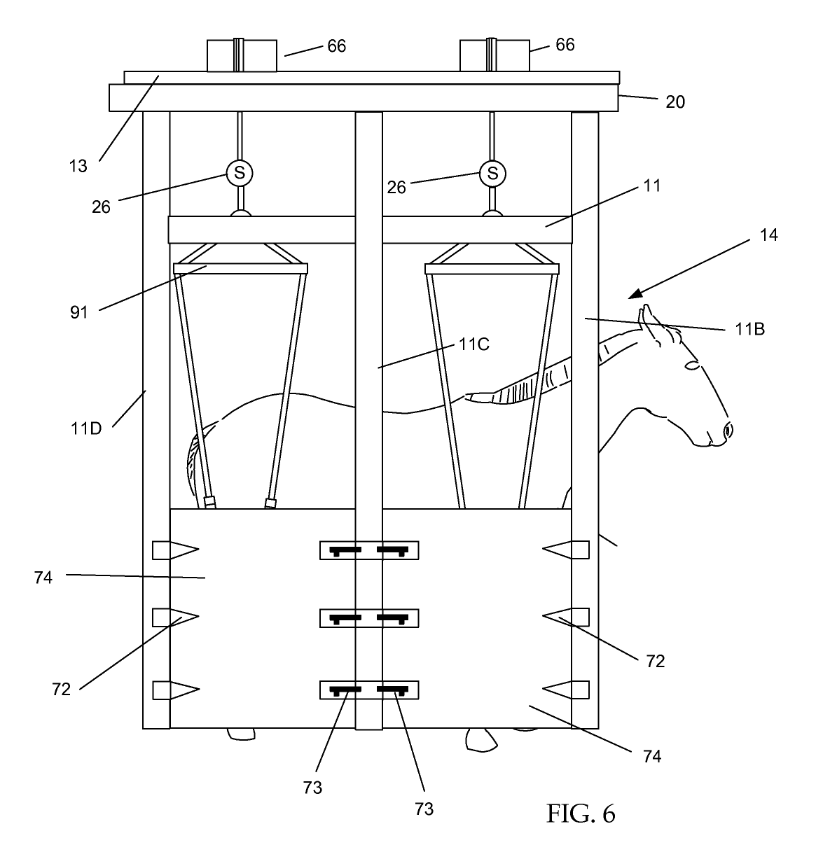

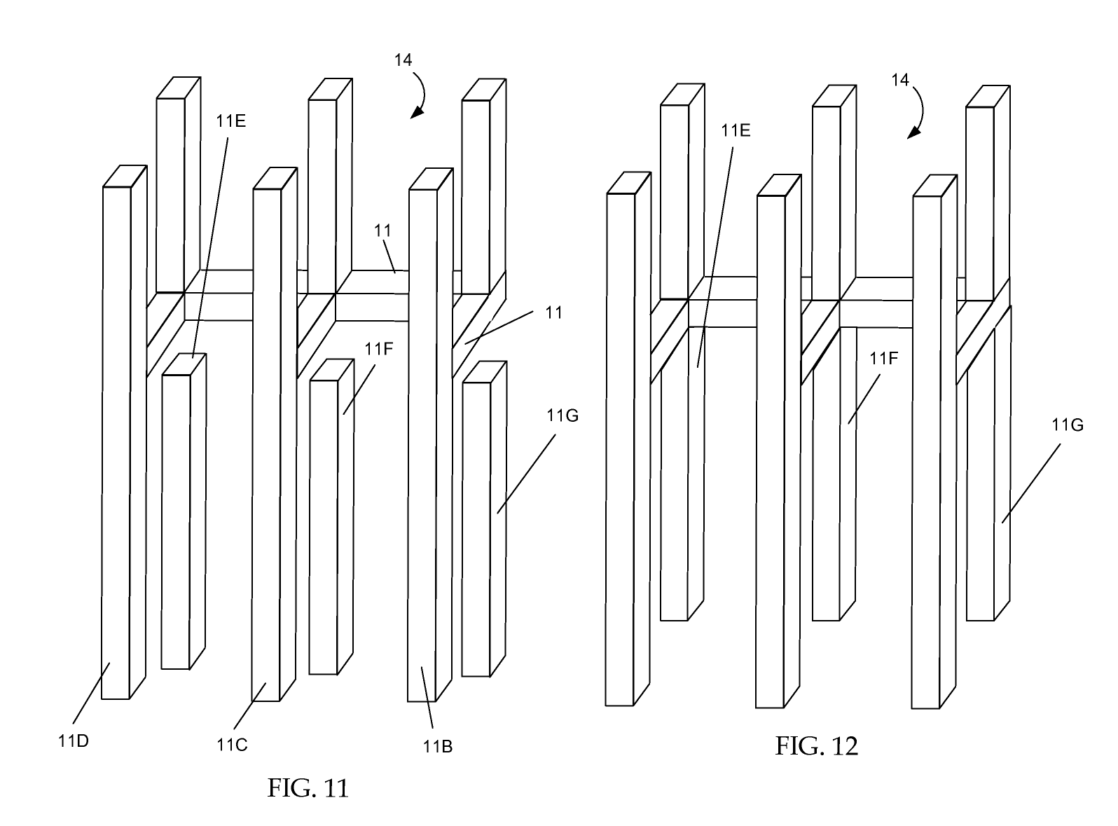

FIG. 6 shows preferred containment stall 14. Containment stall 14 is connected to the bottom of support beams 20. Containment stall 14 contains horse 27 so that it is more comfortable and less likely to become highly agitated. Containment stall 14 includes vertical support beams 11B-11G, horizontal support beam 11 and doors 74 (see also FIGS. 11-12). Doors 74 are connected to vertical support beams 11B-11G via hinges 72 and are bolted shut by bolts 73.

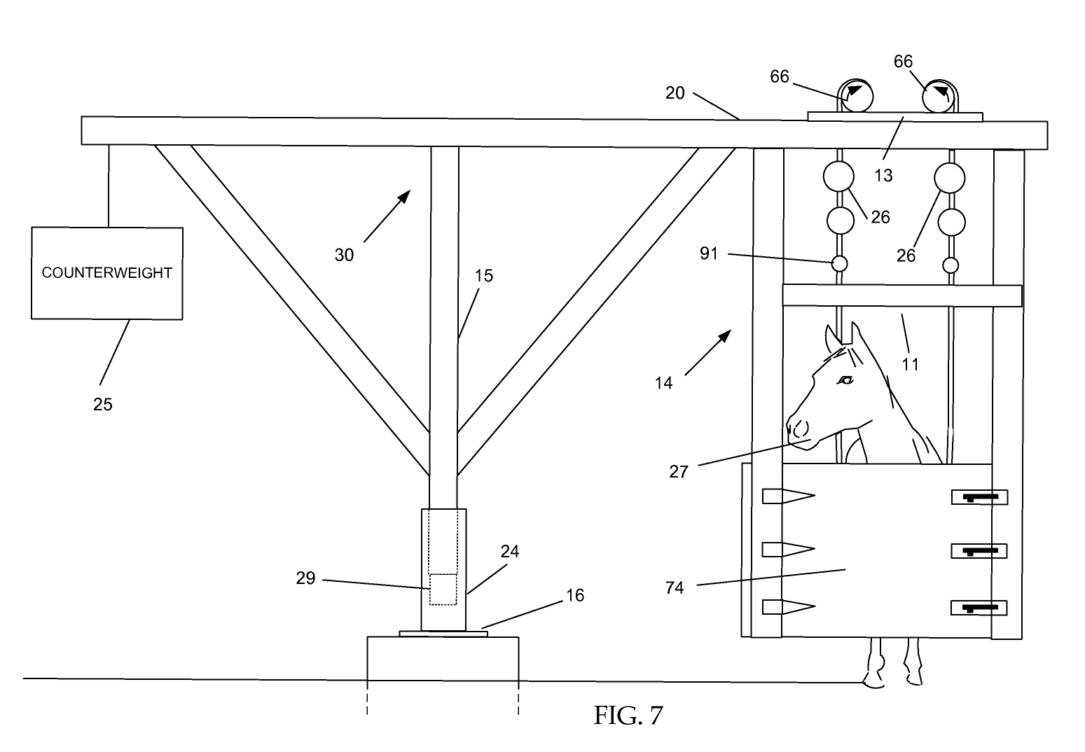

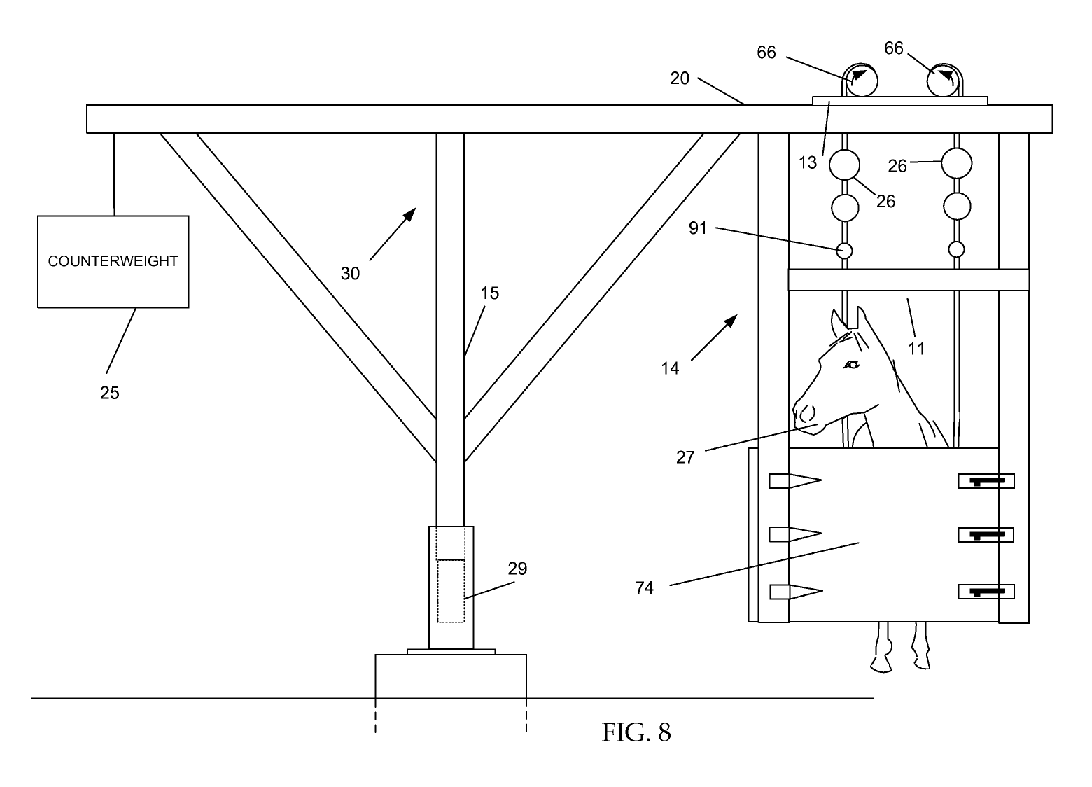

FIG. 7 shows a front view of a preferred embodiment containment stall 14 connected directly to support beam 20. In FIG. 7 hydraulic lifter 29 has lifted support pole 15 upwards so that the horse only has to support just 15 percent of his weight with his legs. If necessary support pole 15 can be moved upwards higher so that the horse is suspended in air so that his legs can be completely rested (see FIG. 8).

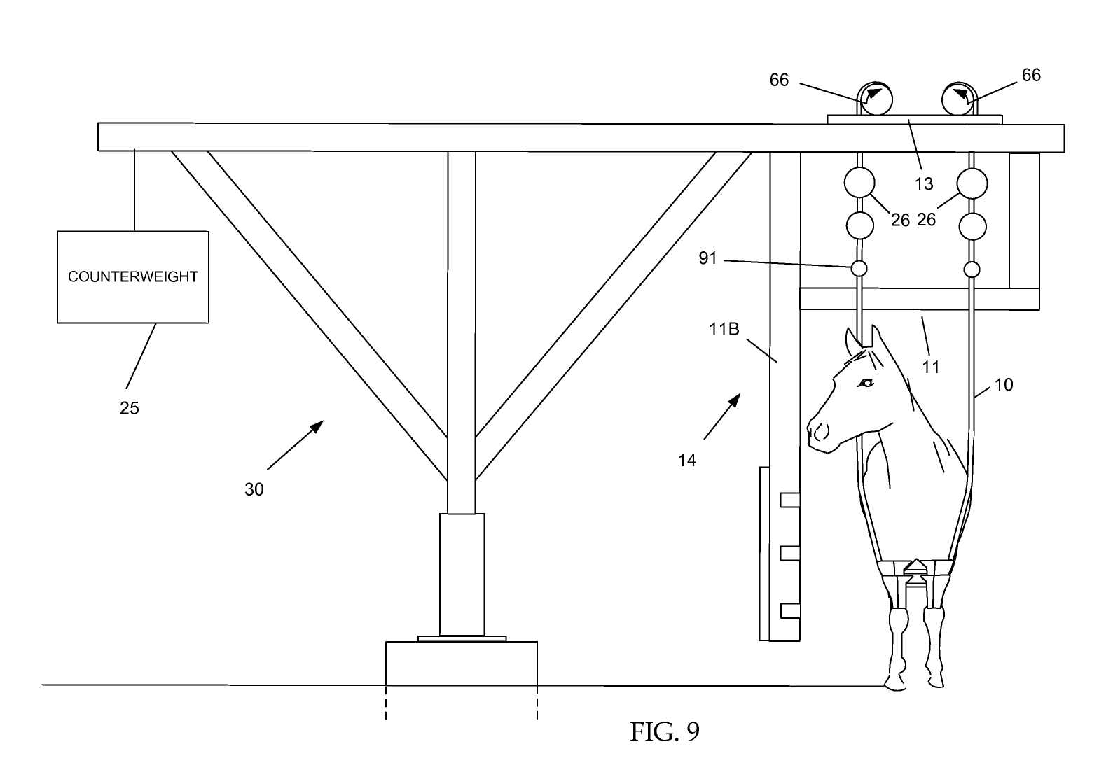

In a preferred embodiment, it is also possible to remove portions of containment stall 14 as the horse begins to mend and to allow easier access to the horse for treatment (see FIG. 9).

### Preferred Method of Utilizing the Horse Lifter

Before attaching a horse to horse lifter 30, the horse is preferably casted (to treat the injury) sedated to relax the horse. Then foreleg harnesses 1 and rear leg harnesses 3 are attached to the horse's legs in a fashion similar to that described above (see FIG. 2). The horse is then connected to horse lifter 30. The horse should then appear as shown in FIG. 9. The user then utilizes remotely controlled winches 66 to bring lifting straps 10 taut.

The user the contains the horse further by installing the remaining portions of containment stall 14 around horse 27 so that the horse is contained as shown in FIGS. 6 and 7. To do this, the user rigidly bolts temporary framing beams 11E, 11F and 11G to containment stall 14, as shown in FIGS. 11 and 12. Beams 11E-11G have an upper part which slides up into receiving areas in containment stall 14. For each temporary framing beam 11E-11G, there are preferably two bolt holes in containment stall 14 which line up precisely with beam 11E-11G bolt holes to allow bolts to be put through and washers and nuts applied.

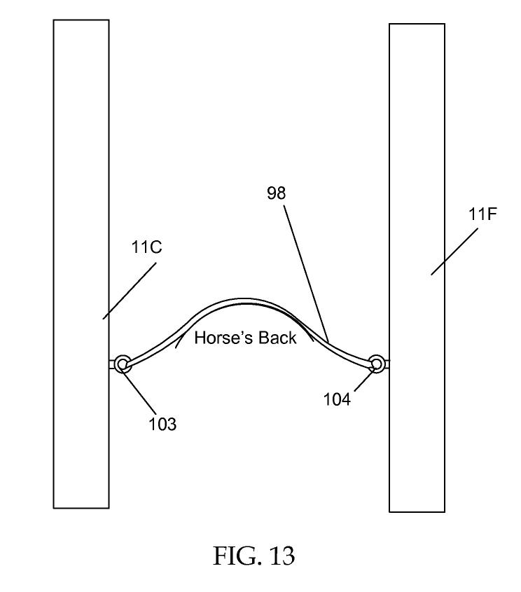

After the beams are installed the user may apply restraining strap 98 (FIG. 13) across the horse's back. Retaining strap 98 functions to help hold the horse in place and prevent him from rearing up or jumping while connected to horse lifter 30. Restraining straps 98 are connected to beams 11C and 11F, as shown. Alternatively, multiple restraining straps 98 may be connected across the horse's back as preferred to properly restrain the horse. Restraining straps 98 may be connected to any of beams 11A-11G as preferred. After beams 11E-11G are installed, the user then installs doors 74 to contain the horse in containment stall 14.

Then the user utilizes hydraulic lifter 29 to lift the horse the desire amount so that that the appropriate amount of weight is carried on each hoof. For example, in one preferred embodiment horse 27 weighs 1200 pounds. The horse veterinarian wishes for ⅓ of the horse's weight to remain on the horse's legs and hooves. Therefore the user utilizes hydraulic lifter 29 and all winches 66 to lift 800 pounds. The user will know he has lifted 800 pounds by referring to scales 26 and adding the weight indicated on each scale. The scales will indicate 200 pounds each.

Alternatively, the user can customize how much weight is felt at each hoof by adjusting each winch 66 independently as preferred. In one example, the user first utilizes forward winches 66 to provided 80 pounds of upward force on the left leg and 120 pounds of upward force on the right leg. Then the user utilizes hydraulic lifter 29 to provide upward force so that rear scales 26 indicate 150 each, the right front scale 26 indicates 270 pounds and the left front scale indicates 230 pounds.

After he is contained in containment stall 14 the horse is now able to stand comfortably on his legs as he is rehabilitated. Additionally, as part of the rehabilitation process, the horse can walk forward in a circular fashion around the axis of provided by rotatable disc 16 (FIG. 7). As the horse heals the weight felt on each hoof can gradually be increased. Additionally portions of containment stall 14 can gradually be removed as horse 27 heals and becomes more relaxed (FIG. 9).

### Preferred Control Connectivity

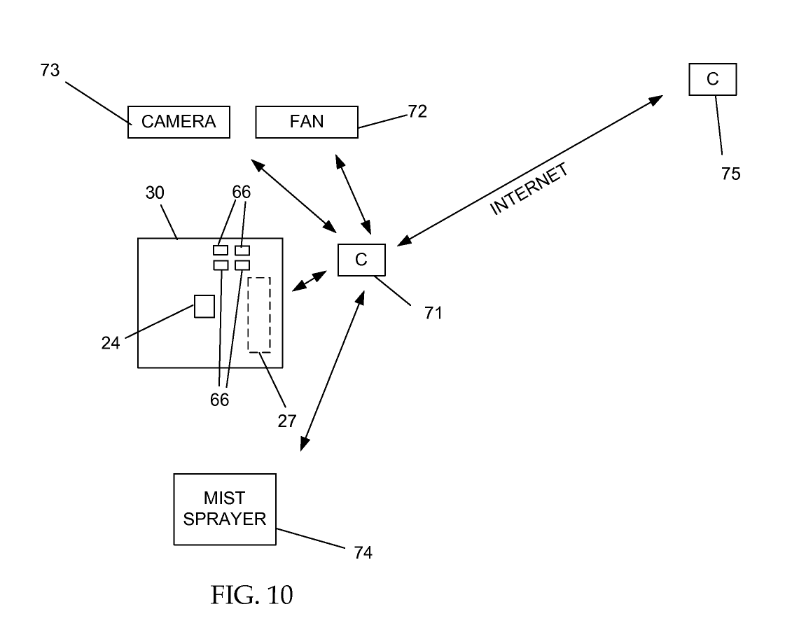

FIG. 10 shows preferred control connectivity for horse lifter 30. In FIG. 10, horse 27 is connected to horse lifter 30 in a manner as described above. Hydraulic lifter 29 and winches 66 are connected via a WIFI wireless network (or via wire connectivity) to control computer 71. Monitor camera 73, cooling fan 72 and mist sprayer 74 are also similarly connected to control computer. Therefore, a user at computer 71 can monitor and control all aspects of horse lifter 30 and the surrounding components. Also, in a preferred embodiment remote control computer 71 is connected to control computer 71 via a computer network, such as the Internet. Through 75, horse 27 may be carefully monitored and controlled. For example, a veterinarian remotely located at computer 75 can monitor horse 27, raise and lower hydraulic lifter 29 and winches 66 as appropriate for the horse's care and control the surrounding components.

Although the above-preferred embodiments have been described with specificity, persons skilled in this art will recognize that many changes to the specific embodiments disclosed above could be made without departing from the spirit of the invention. For example, although the above embodiments each disclosed utilizing horse lifter 30 to lift a horse, it is understood that it could be similarly used to treat any four-legged, injured animal. It could also be used to treat a zebra, a camel, a gazelle, a giraffe, and many others. Therefore, the attached claims and their legal equivalents should determine the scope of the invention.

What is claimed is:

1) A four-legged animal lifter, comprising:
A) a rotatable horse support structure,
B) a plurality of lifting straps extending downward from said rotatable horse support structure,
C) four harnesses connected to said plurality of lifting straps, said four harnesses connected to the legs of the four-legged animal, and
D) a lifting apparatus attached to said rotatable horse structure, said lifting apparatus for lifting said four-legged animal upwards to reduce weight on the legs of said four-legged animal.

2. The four-legged animal lifter as in claim 1, wherein said rotatable horse structure comprises:
A) a rotatable disc, and
B) a rigid support structure connected to said rotatable disc, and
C) an overhead support structure positioned over the top of said four-legged animal and connected to said rotatable horse structure, said plurality of lifting straps extending downward from said overhead support structure.

3. The four-legged animal lifter as in claim 2, wherein said lifting apparatus comprises:
A) a hydraulic lifter connected to said rotatable support disc and said rigid support structure, said hydraulic lifter for providing vertical lifting of said four-legged animal, and
B) four separately controlled lifting winches connected to the top of said overhead support structure, said plurality of lifting straps extending downward from said four lifting winches, said four lifting winches for lifting the legs of said four-legged animal.

4. The four-legged animal lifter as in claim 1 further comprising a containment stall connected to said rotatable horse support structure and surrounding said horse.

5. The four-legged animal lifter as in claim 4 wherein said containment stall includes detachable doors.

6. The four-legged animal lifter as in claim 1 further comprising a plurality of scales attached to said plurality of downward extending lifting straps.

7. The four-legged animal lifter as in claim 1 further comprising a counterweight connected to said rotatable horse support structure, said counterweight for balancing the weight of said four-legged animal.

8. The four-legged animal lifter as in claim 1, wherein said four-legged animal is a horse.

9. The four-legged animal lifter as in claim 1, wherein said four-legged animal lifter is computer controllable and monitored.

10. The four-legged animal lifter as in claim 1, wherein said four-legged animal lifter is remotely computer controllable and monitored via a computer network.

11. The four-legged animal lifter as in claim 10, wherein said computer network is the Internet.

12. The four-legged animal lifter as in claim 1, where two of each said lifting straps are connected to each of said four harnesses, further comprising a spreader bar positioned between said two lifting straps to increase the angle of said lifting straps so that the angle is greater than 90 degrees.

13. The four-legged animal lifter as in claim 1, wherein said four harness are connected to the upper part of each leg of a horse.
